(19) United States
(12) Patent Application Publication
(10) Pub. No.: US 2018/0056428 A1
(43) Pub. Date: Mar. 1, 2018

(54) Dynamic Power Limitation

(71) Applicant: ESAB AB, Gotenburg (SE)

(72) Inventors: Lars Lidander, Vastra Frolunda (SE); Stefan Rickfjord, Kungalv (SE); Jonatan Åkerlind, Hallingsjo (SE)

(21) Appl. No.: 15/685,337

(22) Filed: Aug. 24, 2017

Related U.S. Application Data
(60) Provisional application No. 62/382,025, filed on Aug. 31, 2016.

(51) Int. Cl. B23K 9/10; G05B 19/042

(52) U.S. Cl. CPC B23K 9/1062; G05B 2219/45135; G05B 19/042

(57) ABSTRACT

Dynamic power limitation functionality described herein can be used to continuously calculate a maximum allowed power dissipation for a welding power supply. The maximum allowed power dissipation can be less than a maximum possible power dissipation. The calculated maximum allowed power dissipation can then be used as a dynamic boundary condition for a welding process functionality. The maximum allowed power dissipation can be determined based on temperature so as to enable higher output currents when the power supply operates at lower ends of a temperature scale. Information provided from an output inverter and an input power factor correction (PFC) module can provide inputs for calculating the maximum allowed power dissipation. Information provided by the inverter and the PFC module can include both static design parameters and dynamic sensor information.

### CROSS REFERENCE TO RELATED APPLICATIONS

This application claims the benefit of U.S. Provisional Patent Application No. 62/382,025 filed Aug. 31, 2016, the disclosure of which is incorporated by reference herein in its entirety.

### TECHNICAL FIELD

The present embodiments are related to power supplies for welding type power, that is, power generally used for welding, cutting, or heating.

### BACKGROUND

In many conventional welding power supplies, output power limitation levels are determined based on static design parameters. Such conventional welding power supplies are generally unable to account for operating conditions during on-going welding processes to calculate output power limitation levels. Consequently, the output power limitation levels do not maximize power usage for working conditions, resulting in inefficient power control of the power supply.

It is with respect to these and other considerations that the present disclosure is provided.

### SUMMARY OF THE INVENTION

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments may be generally directed to techniques for providing an adjustable output welding current in a welding power supply. A maximum allowed power dissipation can be determined, and the output welding current can be adjusted based on the determined maximum allowed power dissipation. This technique can be used to enable higher output currents when the welding power supply operates at lower ends of a temperature scale, as well as provide a prediction of a Mean Time Between Failure (MTBF) for a particular welding power supply. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### DESCRIPTION OF FIGURES

FIG. 1 illustrates a welding power supply having dynamic power limitation control.

FIG. 2 illustrates an example of a logic flow for implementing dynamic power limitation control.

### DESCRIPTION OF EMBODIMENTS

Various embodiments may be generally directed to a system architecture for providing dynamic power limitation control of a welding power source and methods for implementing the same. A power limitation level of the welding power source can be dynamically determined by the system as a function of mains input conditions, temperature, and/or other welding conditions including those from different welding modes or methods. The dynamic power limitation level can be determined so as to maximize power usage capability and can be used to control an output of a welding power source.

Various embodiments further provide changeable mean time between failures (MTBF) functionality. Dynamic power limitation control can be used to determine or predict MTBF for a particular welding power source and/or a desired MTBF can be used to adjust calculation of a power limitation level for a welding power source. In general, the embodiments described herein for dynamic power limitation control can be used to increase the power limitation level for working conditions when possible and/or can increase an MTBF value or figure for the welding power source if so desired.

Dynamic power limitation control as described herein can use information from various sub-function modules in a systematic manner to calculate a power dissipation/limitation for any given working condition. The sub-modules can be autonomous or can at least have a high degree of autonomy to provide scalability, longevity, and flexibility to react quickly when necessary.

Overall, the dynamic power limitation functionality described herein can be used to continuously calculate a maximum allowed power dissipation for a welding power supply. The maximum allowed power dissipation can be less than a maximum possible power dissipation. The calculated maximum allowed power dissipation can then be used as a dynamic boundary condition for a welding process functionality. The maximum allowed power dissipation can be determined based on temperature so as to enable higher output currents when the power supply operates at lower ends of a temperature scale. Information provided from an output inverter and an input power factor correction (PFC) module can provide information used to calculate the maximum allowed power dissipation. Information provided by the inverter and the PFC module can include both static parameters and dynamic sensor information.

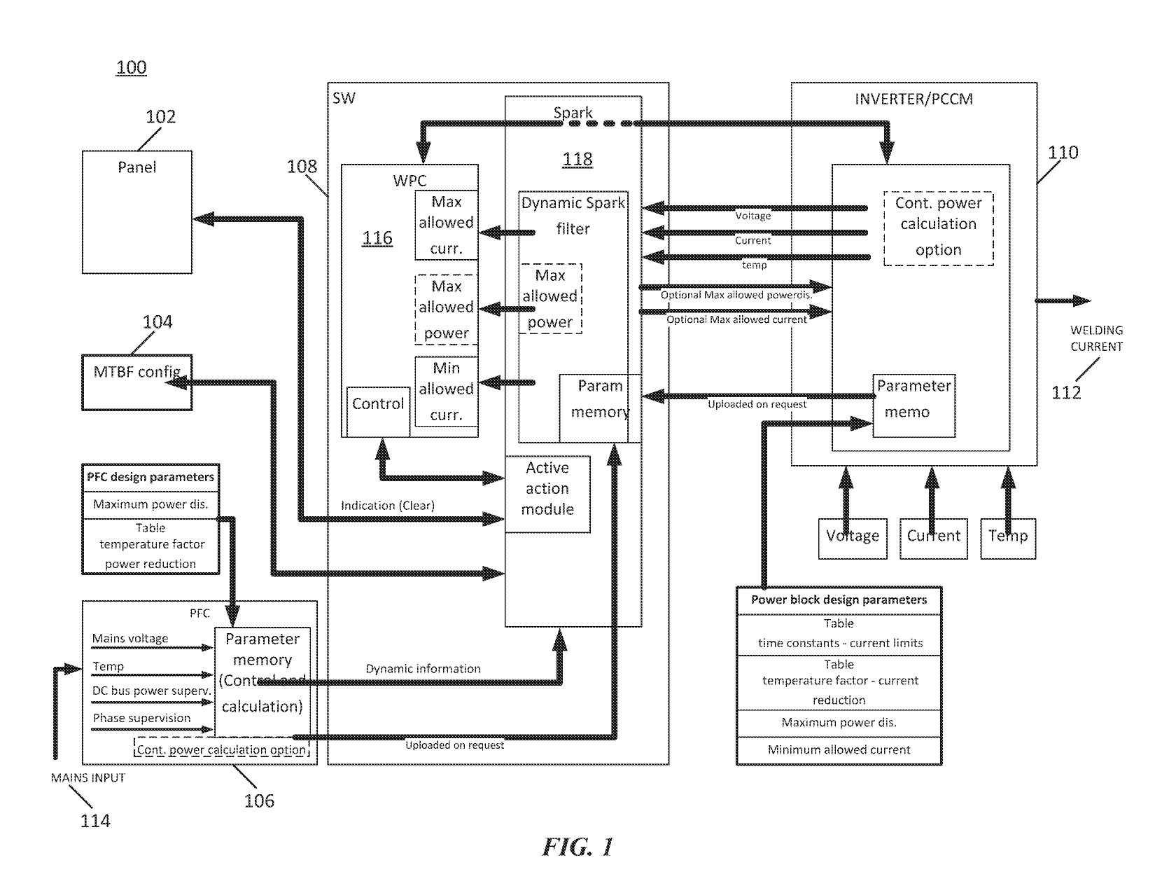

FIG. 1 illustrates a power supply 100 having dynamic power limitation control. The power supply 100 can be, for example, a welding power supply. FIG. 1 shows an exemplary system architecture for the power supply 100. Then power supply 100 can operate according to techniques described herein for dynamically determining a maximum allowed power dissipation.

The power supply 100 can include a number of constituent modules and/or components. As shown in FIG. 1, the power supply 100 can include a panel 102, a mean time between failures (MTBF) module 104, an input power factor correction (PFC) module 106, a software control module 108, and an output inverter module 110. The power supply 100 can receive input power and can generate an output welding current 112. As shown in FIG. 1, the constituent components and modules of the power supply 100 can be interconnected to allow control and other information to flow between the constituent components and modules of the power supply 100.

A mains input 114 can be provided to the PFC module 106. The mains input 114 can represent an input power (e.g., an input current and/or voltage) provided to the power supply 100 and/or can represent a rectified version of an input signal provided to the power supply 100. The mains input 114 can vary based on any variation of the input power provided to the power supply 100. For example, the mains input 114 can vary according to a magnitude and/or phase of an input current and/or input voltage to the power supply 100. The output welding current 112 can be adjusted based on a type of welding or welding mode of the power supply 100.

The panel 102 can represent a physical area of the power supply 100. The panel 102 can include mechanical and/or electrical controls for the power supply 102 that can be adjusted or manipulated by a user. The panel 102 can further include a user interface that can include a display (e.g., a touchscreen) and a data entry module.

The MTBF module 104 can represent a module for configuring or monitoring MTBF for the power supply 100. A user can configure or adjust an MTBF for the power supply 100 using the MTBF module 100. Adjustment of the MTBF can influence or affect operation of the power supply 100 and generation of the output welding current 112. For example, for a longer MTBF, the power supply 100 can be operated more conservatively while for a shorter MTBF, the power supply 100 can be operated at higher or maximum levels for longer durations. By adjusting or configuring the MTBF for the power supply 100, operation of the power supply 100 and the output welding current 112 can be correspondingly dynamically adjusted as discussed in more detail below.

The PFC module 106 can provide power factor correction and/or boosting (e.g., voltage and/or current boosting) of any received input. As shown in FIG. 1, the PFC module can include or be associated with a memory. The memory of the PFC module 106 can include PFC module 106 design parameters. The PFC module 106 design parameters can include a number of parameters such as, for example, maximum power dissipation information or maximum power rating information and/or temperature or power reduction tables. The temperature or power reduction tables can include information that can specify how a maximum allowed power for the inverter module 110 can be varied for changes to a temperature of the PFC module 106 (e.g., how the maximum allowed power for the inverter module 110 can be reduced as the temperature of the PFC module 106 increases). The PFC module 106 design parameters can be static parameters stored in the associated memory of the PFC module 106. One or more of the PFC module 106 design parameters stored in the associated memory of the PFC module 106 can be uploaded or provided to the software control module 108.

In general, the PFC module 106 can be viewed as an energy source for the inverter 110. The PFC module 106 can be viewed as a DC power supply with power factor control. Consequently, fluctuations in the input, output, or operation of the PFC module 106 can influence the output of the inverter module 110. The PFC module 106 can provide supervision or monitoring of any input voltage or current. For example, as shown in FIG. 1, the PFC module 106 can supervise or monitor any input voltage or current (e.g., a mains voltage or current), a temperature of the PFC module 106, operation of any provided DC voltage or current bus (e.g., monitoring of any provided DC voltage bus level), and a phase of any input voltage or current from the mains input 114.

Fluctuations in the mains input 114 can affect operation of the PFC module 106 and can in turn affect any output of the PFC module 106. As the PFC module 106 can affect the welding output current 112 provided by the output inverter 110, fluctuations in the mains input 114 can also affect the welding output current 112. Therefore, the PFC module 106 can continuously monitor the actual input voltage and current information of the mains input 114 and can provide such dynamic information to the software control module 108. Further, the PFC module 106 can also continuously monitor a temperature of the PFC module and can further monitor any provided output current or voltage (e.g., any DC bus power output) and provide information regarding the same on a dynamic basis to the software control module 108.

The output inverter module 110 can control the output welding current 112. As explained in more detail below, operation of the inverter module 110 can be controlled by or modified by the software control module 108. As with the PFC module 106, the inverter module 110 can include or be associated with a memory. The associated memory of the inverter module 110 can include or can store a number of operational or design parameters. The parameters stored in the memory of the inverter module 110 can be considered to be static parameters. These static parameters can include, for example, power block design parameters such as maximum power ratings, long and short term time constant considerations, minimum allowed current information, current reduction tables, and temperature reduction tables.

The long and short term time constraints can be used to distinguish possible mean power dissipation from possible short term time power dissipation. For example, certain components may be able to withstand a relatively higher current for a relatively shorter period of time compared to the current level that can be tolerated for a relatively longer period of time. These short and long term power constraints may be stored in tables that can be accessed. The inverter module 110 can provide or upload the static parameters stored in the associated memory of the inverter module to the software control module 108.

Static parameters stored in the memory of the PFC module 106 and/or static parameters stored in the memory of the inverter module 110 can be provided or uploaded to the software control module 108 at startup of the power supply 100 and/or in response to any request by the software control module 108.

The output inverter module 110 can continuously monitor an output voltage and/or current. Further, the output inverter module 110 can monitor a temperature of any provided current or arc, an operating environment temperature, and a temperature of the inverter module 110 itself. This information monitored by the inverter module 110 can be provided to the software control module 108 on a dynamic basis. That is, voltage, current, and/or temperature information monitored by the inverter module 110 can be continuously provided to the software control module 108.

The number of temperature sensors used by the power supply 100 can vary. In general, temperature sensors can be placed in close proximity to components of the power supply 100 (e.g., the PFC module 106 and/or the inverter module 110) such that a temperature indicative of the component can be measured. External temperatures can also be measured using one or more external temperature sensors. This information can be provided to the software control module 108.

When the power supply 100 includes the use of several temperature sensors, it is possible to calculate the temperature resistance from outside of the power supply 100 (or any constituent component thereof) to any chosen point inside. A dynamic map of temperature resistance can be collected for every specific situation where the power supply 100 may be used. This information, along with any current specific environmental information, can be provided to the software control module 108 as part of, for example, any predictive algorithm implemented by the software control module 108.

The software control module 108 can include one or more sub-modules. For example, as shown in FIG. 1, the software control module 108 can include a welding process control (WPC) module 116 and a dynamic filtering and calculation module 118. The dynamic filtering and calculation module 118 can be implemented using a proprietary software platform.

As described above, the software control module 108 can receive static design parameters from the PFC module 106 and/or the inverter module 110 and can receive dynamic operational parameters from the PFC module 106 and/or the inverter module 110. The software control module 108 can receive any static parameters at power-up or start-up of the power supply 100. Alternatively, or in addition thereto, the software control module 108 can receive any static parameters after requesting the same from the PFC module 106 and/or the inverter module 110 at any time during operation of the power supply 100.

As shown in FIG. 1, the dynamic filtering and calculation module 118 can include an associated memory. The associated memory of the dynamic filtering and calculation module 118 can be considered to be a parameter memory. As indicated in FIG. 1, parameters for the PFC module 106 and/or the inverter module 110 can be provided to the memory of the dynamic filtering and calculation module 118. Further, the dynamic filtering and calculation module 118 can receive any dynamically monitored parameter from the PFC module 106 and/or the inverter module 110.

The dynamic filtering and calculation module 118 can execute any dynamic filtering and calculations based on any received or stored static or dynamic parameters received from the PFC module 106 and/or the inverter module 110. The dynamic filtering and calculation module 118 can calculate a dynamic power limitation level based on any received or stored static or dynamic parameters received from the PFC module 106 and/or the inverter module 110. The dynamic filtering and calculation module 118 can determine consequences to the power supply 100 based on operation of the power supply 100 for the given dynamic parameters. The dynamic filtering and calculation module 118 can further include an active action module to determine what actions are to be taken in response to such dynamic parameters/conditions of the power supply 100. In general, the dynamic filtering and calculation module 118 can use static parameters to determine a maximum output power (or a maximum power dissipation and corresponding maximum output current and/or voltage). The dynamic filtering and calculation module 118 can use the static parameters and the dynamic parameters to subsequently determine a maximum allowed power dissipation (and a maximum allowed output current and/or voltage). In this way, the dynamic filtering and calculation module 118 can use dynamically collected information about a current or on-going welding process to determine a dynamic output boundary condition whereby the maximum allowed power dissipation can be less than the maximum power dissipation possible for the welding power supply 100.

The dynamic filtering and calculation module 118 can provide information to the WPC module 116. For example, the dynamic filtering and calculation module 118 can provide any filtering or calculation result to the WPC module 116. The dynamic filtering and calculation module 118 can provide a calculated dynamic power limitation level to the WPC module 116. The dynamic filtering and calculation module 118 can also provide a maximum allowed current level, a maximum allowed power level, and a minimum allowed current level to the WPC module 116 as indicated in FIG. 1.

The WPC module 116 can include welding process application software. The WPC module 116 can use any information provided by the dynamic filtering and calculation module 118 as an input to a welding process. The WPC module 116 can provide an indication of operation of a welding process given the information provided by the dynamic filtering and calculation module 118. Overall, the software control module 108 can control operation of the inverter module 110 based on the calculations performed by the dynamic filtering and calculation module 118—in particular, a maximum allowed power dissipation, a maximum allowed current level, and/or a maximum allowed voltage level (with each of these maximums not necessary equal to an absolute maximum level but rather a current or dynamic operational maximum).

The MTBF configuration module 104 can be accessible to a user. The MTBF configuration module 104 can provide an input to the active action module of the dynamic filtering and calculation module 118 to adjust an action or decision on the operation of the power supply 100 being determined or made by the dynamic filtering and calculation module 118. Accordingly, the software control module 108 can adjust operation of the power supply 100 (in particular, the operation of the inverter module 110) based on configuration of the MTBF module 104.

The power supply 100 having dynamic power limitation control provides numerous advantages over prior art power supplies that do not include the dynamic power limitation control, functionality, and techniques described herein. By continuously calculating a dynamic power limitation level as a function of temperature, the maximum power usage for working conditions can be expanded when possible as compared to determination of maximum power usage based only on static or sub-static information. A more robust dynamic power limitation level can be determined based on information collected dynamically from the PFC module 106 (or any other input stage) since the instantaneous power capacity of the input of the power supply 100 (as well as the mains input 114 delivery capacity) can be continuously taken into account.

Additionally, the architecture of the power supply 100 can provide the dynamic power level limitation features in a modular manner and lends itself to scalability across product families since expanded capabilities can be supported by adding new static parameters and/or additional sensors. Further, the power supply 100 provides a configurable MTBF. The MTBF can be changed if a product incorporating the power supply 100 or the dynamic power limitation control features described herein is defined to have another expected lifetime figure. Alternatively, the MTBF for a product incorporating the power supply 100 or the dynamic power limitation control features described herein can be fixed or can have a hidden configurability for the user to define.

Overall, the dynamic power limitation control techniques described herein can rely on maximum component power ratings, actual output current, internal temperatures, external temperatures, mains variations and impedances, and can take into account long and short time considerations to provide dynamic power information and/or predictive power information that can then be used to determine an appropriate action to take before reaching any product limitations.

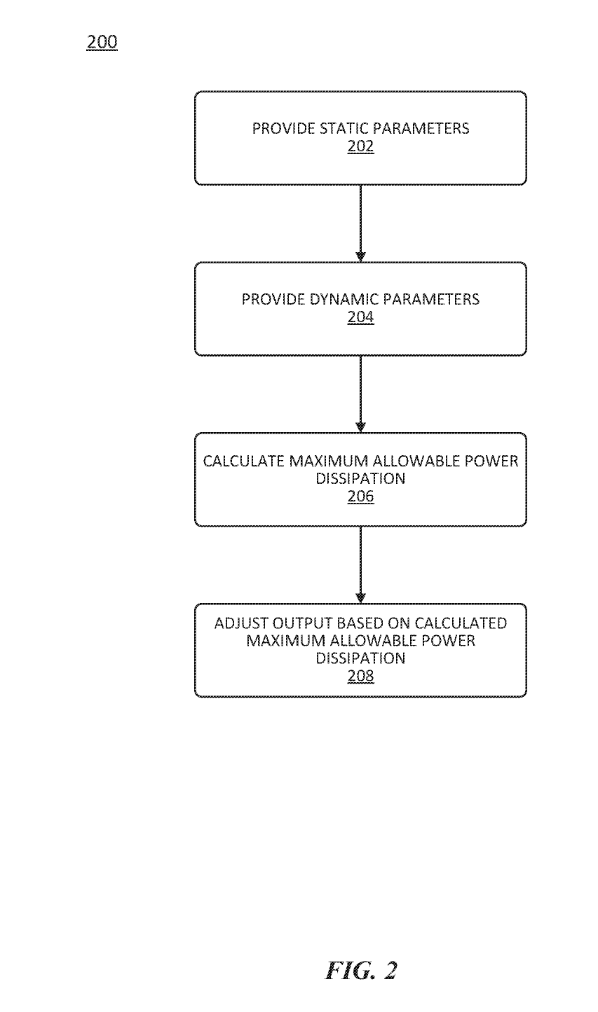

FIG. 2 illustrates an example of a logic flow 200 that may be representative of the implementation of one or more of the disclosed techniques for power dissipation limitation control. For example, logic flow 200 may be representative of operations that may be performed by the welding power supply 100 depicted in FIG. 1.

At 202, static parameters can be provided to a control module of a power supply. The control module can be a software control module. The static parameters can be provided by one or more sub modules of the power supply. For example, the static parameters can be provided by a PFC module and/or an inverter module of the power supply. The static parameters can include PFC design parameters and/or power block design parameters.

At 204, dynamic parameters can be provided to the control module of a power supply. The dynamic parameters can be provided by one or more sub modules of the power supply. For example, the dynamic parameters can be provided by the PFC module and/or the inverter module of the power supply. The dynamic parameters provided by the PFC module can include fluctuations of a mains input to the PFC module. The dynamic parameters provided by the inverter can include output current, voltage, and/or temperature information. In general, the dynamic parameters can include parameters that may fluctuate during operation of the power supply when implementing a particular welding process.

At 206, a maximum allowable power dissipation can be calculated. The maximum allowable power dissipation can be calculated based on the static and/or dynamic parameters provided to the control module. The maximum allowable power dissipation can also be calculated based on an MTBF setting or configuration.

At 208, an output can be adjusted based on the calculated maximum allowable power dissipation. The output can include an output voltage, current, and/or power. Other actions can be taken based on the collected static and dynamic parameters. Further, a maximum possible power dissipation can be determined and boundary conditions and operational conditions can be set to avoid any high risk operation. In general, the output and operation of the power supply can be adjusted in an instantaneous or predictive manner based on the collected static and dynamic parameters.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Thus, the claims set forth below should be construed in view of the full breadth and spirit of the present disclosure as described herein.

What is claimed is:

1. A welding power supply, comprising:
a power factor correction (PFC) module;
a software control module coupled to the PFC module; and
an inverter module coupled to the software control module to provide an output welding current,
wherein the software control module determines a maximum allowed power dissipation based on information provided by the PFC module and the inverter module,
wherein the inverter module adjusts the output welding current based on the determined maximum allowed power dissipation.

2. The welding power supply of claim 1, wherein the maximum allowed power dissipation is less than a maximum possible power dissipation.

3. The welding power supply of claim 1, wherein the information provided by the PFC module and the inverter module comprises static design information.

4. The welding power supply of claim 1, wherein the information provided by the PFC module and the inverter module comprises dynamic sensor information.

5. The welding power supply of claim 4, wherein the dynamic sensor information provided by the PFC module includes fluctuations of a mains input to the PFC module.

6. The welding power supply of claim 4, wherein the dynamic sensor information provided by the inverter module includes an output voltage, current, and temperature.

7. The welding power supply of claim 1, wherein the software control module directs the inverter module to adjust the output welding current.

8. The welding power supply of claim 1, wherein the maximum allowed power dissipation is based on a configurable mean time between failures (MTBF) setting.

9. A method, comprising:
providing static design parameters to a power supply controller of a welding system;
providing dynamic sensor information to the power supply controller;
calculating a maximum allowed power dissipation level;
adjusting generation of an output welding current based on the calculated maximum allowed power dissipation.

10. The method of claim 9, wherein the dynamic sensor information is provided by a power factor correction (PFC) module.

11. The method of claim 10, wherein the dynamic sensor information comprises fluctuations of a mains input to the PFC module.

12. The method of claim 9, wherein the dynamic sensor information is provided by an output inverter module.

13. The method of claim 12, wherein the dynamic sensor information comprises an output voltage, current, and temperature.

14. The method of claim 9, further comprising configuring a mean time between failures (MTBF) setting, wherein at least one of the generated output current and the calculated maximum allowed power dissipation level is based on the MTBF setting.

15. The method of claim 9, wherein the software control module determines the maximum allowed power dissipation based on a dynamic map of temperature resistance calculated based on temperature sensor information and current environmental conditions.

16. The method of claim 9, wherein the maximum allowed power dissipation is determined using a power reduction table, the power reduction table providing the maximum allowed power as a function of a temperature.

17. The method of claim 16, wherein the maximum allowed power dissipation is reduced as the temperature increases based upon the power reduction table.

18. The method of claim 9, wherein the output welding current is adjusted upon a long term time constraint and a short term time constraint, the long term time constraint indicating an amount of time that a first current can be tolerated by a component and the short term time constraint indicating another amount of time that a second current, higher than the first current, can be tolerated by the same component.

19. The method of claim 9, wherein the maximum allowed power dissipation is calculated using the static design parameters and the dynamic sensor information containing information about a current welding process.

20. The method of claim 9, wherein the maximum allowed power dissipation is determined based on temperature.
